(19) United States
(12) Patent Application Publication
(10) Pub. No.: US 2008/0242747 A1
(43) Pub. Date: Oct. 2, 2008

(54) Gel Yield Improvements

(76) Inventors: Bruce Lucas, Marlow, OK (US); Glenn Weightman, Duncan, OK (US); Harold Walters, Duncan, OK (US); Jimmie Weaver, Duncan, OK (US); Steven Wilson, Loco, OK (US); Billy Slabaugh, Duncan, OK (US)

Correspondence Address: JOHN W. WUSTENBERG, P.O. BOX 1431, DUNCAN, OK, 73536, US

(21) Appl. No.: 11/692,752

(22) Filed: Mar. 28, 2007

(51) Int. Cl. B01J 13/00

(52) U.S. Cl. 516/99; 516/98

(57) ABSTRACT

A process of increasing the viscosity of a gel, or the yield of a hydratable material includes heating a hydratable material, an aqueous component or both, prior to mixing the hydratable material with the aqueous component. In certain instances, the aqueous component is heated to a temperature of at least about 100° F., and the hydratable material component and the heated aqueous component are mixed together to form a gel in certain instances, the hydratable material component is heated to a temperature of at least about 100° F., and the heated hydratable material component and the aqueous component are mixed together to form a gel.

### TECHNICAL FIELD

The present invention relates generally to fluid hydration, including the hydration of fracturing fluids.

### BACKGROUND

Various hydratable materials may be used to viscosify fracturing fluids. The hydratable material selected for a particular use may be based on a number of factors, including the rheological properties, economics, and hydration ability of the material. The term “hydration” is used to describe the process wherein the hydratable material solvates or absorbs water (hydrates) and swells in the presence of water.

The use of a hydratable material in fracturing fluids often requires the construction and maintenance of hydration tanks. The hydratable material is typically mixed with water and allowed to hydrate in a hydration tank before use. The water typically used for mixing is generally used at the temperature of the water that is available. Thus, the water typically used is at ambient temperature, or about room temperature (about 68° F.), or may have a slightly decreased or slightly elevated temperature, such as from about 60° F. to about 80° F. Once the hydratable material has hydrated, generally forming a gel, the hydrated material may be used as a component in a fracture stimulation fluid.

### SUMMARY

In one aspect, a process for increasing the yield of a hydratable material is described that includes heating an aqueous component to a temperature of at least about 100° F., and mixing a hydratable material component and the heated aqueous component together to form a gel. The hydratable material may include a guar. Variously, the viscosity of the gel may be at least 1% greater than a comparable gel formed using an aqueous component at a temperature less than 80° F., or may be at least 5% greater than a comparable gel formed using an aqueous component at a temperature less than 80° F., or may be at least 10% greater than a comparable gel formed using an aqueous component at a temperature less than 80° F. Variously, the aqueous component may be heated to a temperature of about 110° F. to about 160° F., or may be heated to a temperature of about 130° F. to about 145° F. The process may increase the yield of a hydratable material in a fracturing fluid.

In another aspect, a process for increasing the yield of a hydratable material is described that includes heating a hydratable material component to a temperature of at least about 100° F., and mixing the heated hydratable material component and an aqueous component together to form a gel. The hydratable material may include a guar. Variously, the viscosity of the gel may be at least 1% greater than a comparable gel formed using a hydratable material at a temperature less than 80° F., or may be at least 5% greater than a comparable gel formed using a hydratable material at a temperature less than 80° F., or may be at least 10% greater than a comparable gel formed using a hydratable material at a temperature less than 80° F. The hydratable material may be heated to a temperature of at least about 120° F. The hydratable material may be heated using microwaves. The process may increase the yield of a hydratable material in a fracturing fluid.

In another aspect, a process for increasing the yield of a hydratable material is described that includes heating a hydratable material component, and mixing the heated hydratable material component and an aqueous component together to form a gel. Variously, the hydratable material component may be heated using microwaves for at least 10 seconds, or may be heated using microwaves for at least 15 seconds. The viscosity of the gel may be at least 1% greater than a comparable gel formed using a non-heated hydratable material component, or may be at least 5% greater than a comparable gel formed using a non-heated hydratable material component, or may be at least 10% greater than a comparable gel formed using a non-heated hydratable material component. The process may increase the yield of a hydratable material in a fracturing fluid.

In another aspect, a process for increasing the yield of a hydratable material is described that includes heating an aqueous component to a temperature of at least about 100° F., heating a hydratable material component to a temperature of at least about 100° F., and mixing the heated hydratable material component, and the heated aqueous component together to form a gel. The hydratable material may include a guar. The viscosity of the gel may be at least 1% greater than a comparable gel formed using non-heated components, or may be at least 5% greater than a comparable gel formed using non-heated components, or may be at least 10% greater than a comparable gel formed using non-heated components. Variously, the aqueous component may be heated to a temperature of about 110° F. to about 160° F., or may be heated to a temperature of about 130° F. to about 145° F. The hydratable material may be heated to a temperature of at least about 120° F. The hydratable material may be heated using microwaves. The process may increase the yield of a hydratable material in a fracturing fluid.

The details of one or more embodiments of the invention are set forth in the accompanying drawings and the description below. Other features, objects, and advantages of the invention will be apparent, from the description and drawings, and from the claims.

### DESCRIPTION OF DRAWINGS

FIG. 1 is a process drawing showing heating of the hydratable material prior to mixing with the aqueous component.

FIG. 2 is a process drawing showing heating of the aqueous component prior to mixing with the hydratable material.

FIG. 3 is a process drawing showing heating of the hydratable material and heating of the aqueous component prior to mixing.

FIG 4 is a graph of mixing temperature against viscosity for the hydration samples.

### DETAILED DESCRIPTION

Heating may be used to increase the yield of a hydratable material in hydration. Therefore, less hydratable material may be used to produce a gel having a certain gel strength, or the same amount of hydratable material may produce a gel having a greater gel strength. An aqueous component, such as water or water and other materials, is mixed with a hydratable material, such as a powder. One or more of the aqueous component or hydratable material component used is heated prior to mixing the hydratable material with water. Other, additional components may also be added to the composition. The process may increases the yield of a hydratable material in a fracturing fluid. The process may increase the yield of a fracturing fluid.

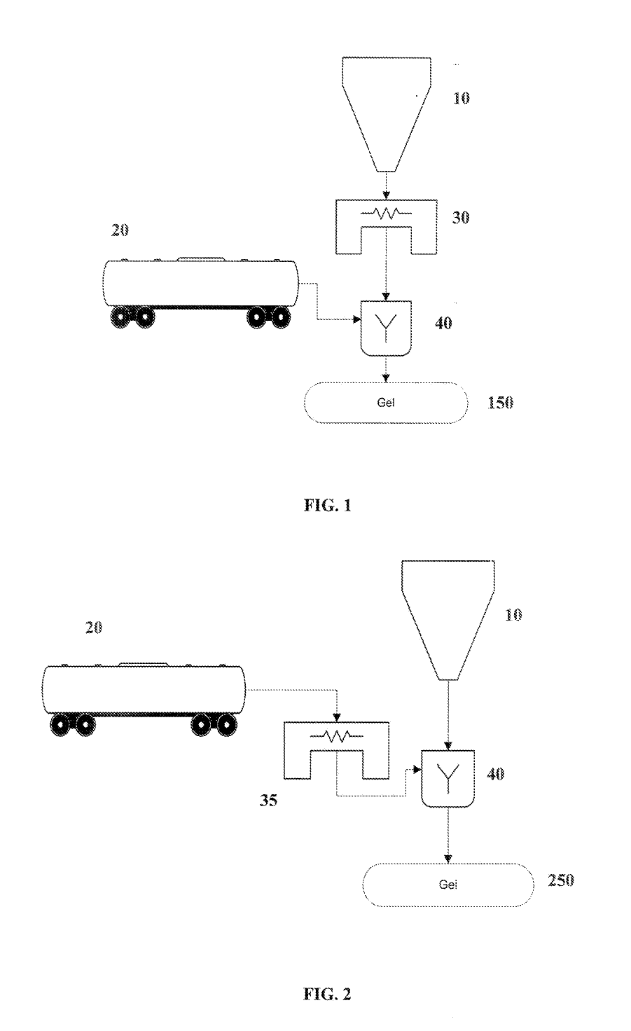

FIG. 1 is a process drawing showing heating of the hydratable material prior to mixing with the aqueous component. As shown in FIG 1, a hydratable material 10 may be heated 30 prior to mixing. An aqueous component 20 is mixed 40 with the heated hydratable material to produce a gel 150.

In one approach, as shown in FIG. 1, the hydratable material is heated prior to mixing with the aqueous component. The temperature used may depend on various factors including concentration of hydratable material to be used, timing, mixing conditions, rate and volume of materials, etc. The hydratable material may be heated to an elevated temperature, such as about 100° F. or higher, about 125° F. or higher, or about 150° F. or higher. The hydratable material may be heated to a temperature at which it is still able to mix readily with the aqueous component. Generally, this means that mixing should not cause significant amounts of steam, etc. Thus, the hydratable material may generally be heated up to a temperature of about 250° F. or less, about 225° F. or less, or about 200° F. or less.

FIG. 2 is a process drawing showing heating of the aqueous component prior to mixing with the hydratable material. As shown in FIG. 2, an aqueous component 20 may be heated 35 prior to mixing. A hydratable material 10 is mixed 40 with the heated aqueous component to produce a gel 250.

In another approach, as shown in FIG. 2, the aqueous component is heated to an elevated temperature prior to mixing with the hydratable material. The temperature used may depend on various factors including concentration of hydratable material to be used, timing, mixing conditions, rate and volume of materials, etc. In various embodiments, the water may be heated to a temperature of about 100° F. or higher, about 110° F. or higher, about 120° F. or higher, about 125° F. or higher, about 130° F. or higher, or higher than 130° F. Although the aqueous temperature may be heated to a higher temperature, at higher temperatures the viscosity of the mixture may decrease. The aqueous component may be heated to a temperature of less than 212° F., or about 200° F. or less. Preferably, the aqueous component will be heated to a temperature of 175° F. or less, 160° F. or less, 150° F. or less, or 145° F. or less.

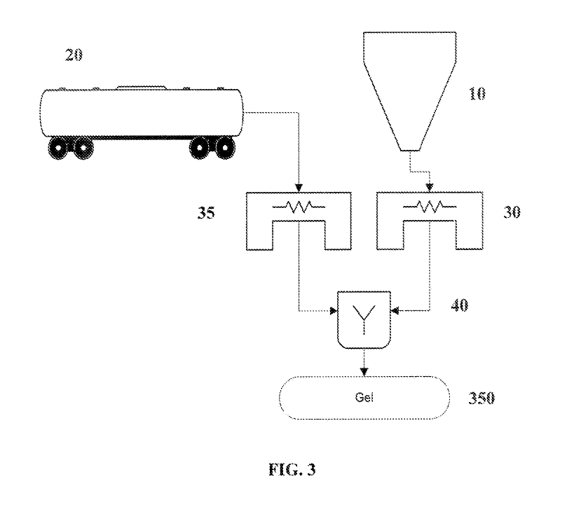

FIG. 3 is a process drawing showing heating of the hydratable material and heating of the aqueous component prior to mixing. In some implementations, as shown in FIG. 3, both components may be heated prior to mixing. As shown in FIG 3, a hydratable material 10 may be heated 30 prior to mixing, and an aqueous component 20 may be heated 35 prior to mixing. The heated hydratable material and heated aqueous components are then mixed 40 to produce a gel 350.

The aqueous component and/or hydratable material (e.g., one or more components) may be heated using various methods. In one embodiment, the one or more components may be heated by the application of direct heat, such as gas or electrical heating. In one embodiment, the one or more components may be heated using microwaves. In one embodiment, the one or more components may be heated using heat transfer from an area of elevated temperature. In one embodiment, the one or more components may be heated using reflective heating, such as concentrated solar heating. Other methods of heating may also be used. The various components may be heated using temperature ranges as described earlier.

Heating one or more of the components prior to mixing may improve the final viscosity yield over mixing without preheating. The increase in viscosity means that a stronger gel may be made using the same amount of material, or that a similar strength gel may be produced using less hydratable material, as compared to a process that does not heat a component prior to mixing. The viscosity yield may be 1% or greater, 2% or greater, 3% or greater, 4% or greater, 5% or greater, 6% or greater, 7% or greater, 8% or greater, 9% or greater, or 10% or greater compared to a process that does not heat a component prior to mixing to a temperature of at least 80° F., or a temperature of at least 100° F.

The heating of one or more components prior to mixing may also increase the rate of hydration of the hydratable material. Thus, less time would be required for the material to reach a viscosity required for use.

The hydratable material may be provided in a variety of forms. For example, the hydratable material may be in powder form (“flour”), crystals, or other non-hydrated form.

The hydratable material used may include natural and derivatized hydratable polymers, such as guar gums. Examples of modified guar gums include carboxyalkyl derivatives such as carboxymethyl guar, and hydroxyalkyl derivatives such as hydroxypropyl guar, and carboxymethylhydroxypropyl guar (CMHPG). Other examples include derivatives such as carboxyalkylguar, carboxyalkylhydroxyalkylguar, and the like, wherein the alkyl groups may comprise methyl, ethyl or propyl groups. The guar gums may be ground to different particle sizes. In some cases, the guar gums may include a coating or associated material. Typically, these modifications may affect the speed of hydration, final viscosity, etc.

A wide range of hydratable material concentrations may be used. In various implementations, the hydratable material may be present in the composition at a sufficient concentration to produce a final gel of 1 pound per 1000 gallons or more, 10 pounds per 1000 gallons or more, 20 pounds per 1000 gallons or more, 40 pounds per 1000 gallons or more, 50 pounds per 1000 gallons or more, 75 pounds per 1000 gallons, or 100 pounds per 1000 gallons or more. Typically, the concentration of hydratable material used may vary based on a number of factors that may include the hydratable material selected, the final desired concentration, the hydration yield increase, etc.

The aqueous component used may be obtained from a variety of sources. Variously, the water used may be clean water, standing water (i.e. from a lake or pond) stream water, well water, or the water may be reused from another application, or other source.

Other components may also be added. Typically a salt may be added to promote hydrolysis. Examples of salts that may be used include Potassium Chloride, Sodium Chloride, Calcium Chloride, Ammonium Chloride, Potassium Bromide, Sodium Bromide, Calcium Bromide, Zinc Bromide, Sodium Formate, and Potassium Formate, or other salts. The other components may be mixed before, at the same time as, or after the hydratable component is mixed with the aqueous component.

### EXAMPLES

### Example 1

### Heated Water Gel Hydration Test Method

Samples for gel hydration testing were prepared using the amounts of materials, temperatures, and times as shown on Table 1 and the steps described below:

1. A first viscometer was setup using a ⅕ spring with an air cooling circuit (Fann Model 35, available from Fann Instrument Company, Houston, Tex.), with a rotor and bob preheated by using heated water at 165° F.

2. A second viscometer was setup using a ⅕ spring (Fann Model 35) with rotor and bob at room temperature.

3. About 300 mL of deionized water was heated to a temperature of about 75-77° F.

4. The water was then placed in a blender jar, and stirred at 2,800 rev/min±10 rev/min using a Chandler Constant Speed Mixer 3060 (available from Chandler Engineering, Tulsa, Okla.).

5. The amount of KCl (as shown) was added to the blender jar while blending the water.

6. The amount of WG-35 dry gelling agent (available from Halliburton, Houston, Tex.) shown in Table 1 was added into the vortex (to form a 40 lb/Mgal) while blending the mixture.

7. After the mixing time reported in Table 1, the mixing was stopped, and 150 mL of the sample was poured into a sample cup, and 50 mL of the sample was poured into a beaker.

8. The 150 mL in the sample cup (“reference”) was placed on the second viscometer.

9. After a delay, as shown in Table 1, seconds from the end of mixing (in step 3), the 50 mL sample in the beaker was placed into a microwave and microwaved on high for the time shown. After heating, the mixture had the temperature shown in Table 1.

10. The beaker was removed from the microwave and placed on the first viscometer.

11. The first and second viscometers were set to 300 rev/min.

TABLE 1
Heated Water Gel Hydration Test Method

| RUN # | A | B | C | D | E | F | G |
|---|---|---|---|---|---|---|---|
| lbs Gel/1000 gal | 40 | 40 | 80 | 80 | 80 | 80 | 80 |
| Water (g) (actual) | 300.70 | 300.10 | 300.40 | 300.40 | 300.10 | 300.00 | 300.10 |
| start Water Temp (F.) | 75.70 | 74.20 | 74.20 | 73.30 | 75.30 | 74.40 | 75.00 |
| Blender RPM (actual) | 2803 | 2804 | 2797 | 2804 | 2804 | 2800 | 2800 |
| KCL g (actual) | 6.00 | 6.00 | 6.00 | 6.00 | 6.00 | 6.00 | 6.00 |
| Powder g (reqd) | 1.44 | 1.44 | 2.88 | 2.88 | 2.88 | 2.88 | 2.88 |
| Powder g (actual) | 1.5 | 1.4 | 1.4 | 1.4 | 1.4 | 1.4 | 1.4 |
| mix time sec (reqd) | 60 | 60 | 60 | 15 | 15 | 8 | 15 |
| start mixing (time) | 0:00:00 | 0:00:00 | 0:00:00 | 0:00:00 | 0:00:00 | 0:00:00 | 0:00:00 |
| end mixing (time) | 0:01:00 | 0:01:00 | 0:01:00 | 0:00:15 | 0:00:15 | 0:00:08 | 0:00:15 |
| delay time (sec) | 60 | 60 | 20 | 5 | 5 | 15 | 15 |
| Start heat | 0:02:00 | 0:02:00 | 0:01:20 | 0:00:20 | 0:00:20 | 0:00:23 | 0:00:30 |
| Heat Time (sec) | 30 | 35 | 35 | 35 | 35 | 35 | 35 |
| Hi Temp (F.) | 147 | 157 | 160.6 | 168 | 168 | 168 | 150 |

### Example 2

### Heated Water Gel Hydration Test Results

The temperature, viscosity, and hydration % of the samples were measured periodically, and are reported in Tables 2-8. The time reported is the elapsed time from the addition of the dry gel powder to the water. In addition, a pH measurement was periodically obtained using the remaining fluid from the mixer jar. The pH is also reported on Tables 2-8. The % increase in viscosity at each sample time is also reported in Tables 2-8.

After the viscosity reading taken at 30 minutes, the viscometers were stopped and the fluid allowed to remain static until the 59 minute point, at which time both viscometers were restarted, and the viscosity and temperature recorded.

For several comparisons (samples A-E), both heated and non-heated samples were heated using a microwave on a high setting for approx. 60 seconds, and a final heated temperature and viscosity are reported on Tables 2-6 (“Reheated”).

Samples F and G were allowed to rest for extensive time at room temperature, after which the samples were tested, and a final temperature and viscosity are reported on Tables 7-8.

TABLE 2
Sample A Test Results

| | Heated | | | Non-Heated Reference | | | | |
|---|---|---|---|---|---|---|---|---|
| | | Temp | | | Temp | | | |
| | | Corr | | | Corr | | | % |
| | | Viscosity | | | Viscosity | | | hydration |
| Time (min) | Temp° F. | (cP) | % hyd | Temp° F. | (cP) | % hyd | pH | increase |
| 4 | 143 | 37.0 | 99.9 | 77 | 32.4 | 87.6 | | 14% |
| 5 | 140 | 38.4 | 103.8 | 76.8 | 33.0 | 89.2 | | 16% |
| 10 | 129.6 | 40.2 | 108.6 | 76.2 | 35.0 | 94.6 | | 15% |
| 20 | 104.2 | 40.1 | 108.3 | 76.8 | 35.6 | 96.1 | 7.48 | 13% |
| 30 | 94.4 | 40.7 | 110.1 | 77.2 | 36.7 | 99.1 | 7.62 | 11% |
| 60 | 84.2 | 41.4 | 111.7 | 77.7 | 37.0 | 100.0 | 7.65 | 12% |
| Reheated | 103 | 38.8 | 104.7 | 111.1 | 38.8 | 104.8 | 7.17 | 0% |

TABLE 3
Sample B Test Results

| | Heated | | | Non-Heated Reference | | | | |
|---|---|---|---|---|---|---|---|---|
| | | Temp | | | Temp | | | |
| | | Corr | | | Corr | | | % |
| | | Viscosity | | | Viscosity | | | hydration |
| Time (min) | Temp° F. | (cP) | % hyd | Temp° F. | (cP) | % hyd | pH | increase |
| 3 | 157 | 29.5 | 91.5 | 82.6 | 27.7 | 85.9 | 7.18 | 6% |
| 4 | 152.6 | 33.6 | 104.3 | 81.8 | 28.0 | 86.8 | | 20% |
| 5 | 148.1 | 34.6 | 107.5 | 81.4 | 28.6 | 88.6 | | 21% |
| 10 | 128 | 35.8 | 111.3 | 80.3 | 31.1 | 96.7 | | 15% |
| 20 | 104.9 | 36.3 | 112.8 | 78.1 | 31.8 | 98.7 | | 14% |
| 30 | 93.2 | 37.2 | 115.4 | 77.4 | 32.3 | 100.2 | | 15% |
| 60 | 79.6 | 37.6 | 116.6 | 75.9 | 32.2 | 100.0 | 7.45 | 17% |
| Reheated | 125 | 38.6 | 119.7 | 108.8 | 28.5 | 88.5 | | 35% |

TABLE 4
Sample C Test Results

| | Heated | | | Non-Heated Reference | | | | |
|---|---|---|---|---|---|---|---|---|
| | | Temp | | | Temp | | | |
| | | Corr | | | Corr | | | % |
| | | Viscosity | | | Viscosity | | | hydration |
| Time (min) | Temp° F. | (cP) | % hyd | Temp° F. | (cP) | % hyd | pH | increase |
| 2 | 160.6 | 29.8 | 90.2 | 73.7 | 17.2 | 52.2 | | 73% |
| 3 | 158 | 31.8 | 96.5 | 73.7 | 24.5 | 74.2 | | 30% |
| 4 | 152 | 32.2 | 97.5 | 73.7 | 28.0 | 85.0 | 6.5 | 15% |
| 5 | 148.4 | 33.9 | 102.7 | 73.7 | 28.2 | 85.6 | | 20% |
| 10 | 123.4 | 34.3 | 103.9 | 73.5 | 30.3 | 91.8 | | 13% |
| 20 | 101.8 | 34.2 | 103.7 | 73.7 | 32.4 | 98.3 | | 6% |
| 30 | 90.7 | 35.8 | 108.6 | 73.9 | 32.8 | 99.3 | | 9% |
| 60 | 77.7 | 36.0 | 109.1 | 74.5 | 33.0 | 100.0 | 6.86 | 9% |
| Reheated | 132 | 35.4 | 107.3 | 122.9 | 33.7 | 102.2 | | 5% |

TABLE 5
Sample D Test Results

| | Heated | | | Non-Heated Reference | | | | |
|---|---|---|---|---|---|---|---|---|
| | | Temp | | | Temp | | | |
| | | Corr | | | Corr | | | % |
| | | Viscosity | | | Viscosity | | | hydration |
| Time (min) | Temp° F. | (cP) | % hyd | Temp° F. | (cP) | % hyd | pH | increase |
| 1.5 | 170 | 20.4 | 58.1 | 74.7 | 13.8 | 43.4 | 6.72 | 34% |
| 2 | 160 | 26.6 | 75.5 | 74.7 | 17.3 | 54.6 | | 38% |
| 3 | 153.2 | 29.7 | 84.3 | 74.6 | 22.1 | 69.7 | | 21% |
| 4 | 147 | 30.8 | 87.5 | 74.7 | 26.5 | 83.6 | | 5% |
| 5 | 144 | 32.1 | 91.2 | 74.8 | 28.2 | 88.9 | | 3% |
| 10 | 124.3 | 32.8 | 93.2 | 74.9 | 30.6 | 96.2 | | −3% |
| 20 | 102.9 | 33.8 | 96.0 | 75.3 | 31.5 | 99.1 | | −3% |
| 30 | 92.9 | 34.2 | 97.2 | 75.7 | 31.8 | 100.0 | | −3% |
| 60 | 80.5 | 35.2 | 100.0 | 75.7 | 31.8 | 100.0 | 7.12 | 0% |

TABLE 6
Sample E Test Results

| | Heated | | | Non-Heated Reference | | | | |
|---|---|---|---|---|---|---|---|---|
| | | Temp | | | Temp | | | |
| | | Corr | | | Corr | | | % |
| | | Viscosity | | | Viscosity | | | hydration |
| Time (min) | Temp° F. | (cP) | % hyd | Temp° F. | (cP) | % hyd | pH | increase |
| 2 | 159 | 39.9 | 123.2 | 76.7 | 30.0 | 92.7 | 9.61 | 33% |
| 3 | 155 | 40.1 | 123.8 | 76.7 | 31.9 | 98.6 | | 26% |
| 4 | 152 | 40.3 | 124.2 | 76.8 | 32.0 | 98.6 | | 26% |
| 5 | 148.5 | 40.2 | 124.1 | 76.7 | 32.2 | 99.2 | | 25% |
| 10 | 129.5 | 38.5 | 118.8 | 76.7 | 32.4 | 99.9 | | 19% |
| 20 | 107.4 | 36.8 | 113.4 | 76.8 | 32.4 | 99.9 | | 13% |
| 30 | 93.8 | 35.5 | 109.4 | 76.8 | 32.4 | 99.9 | | 9% |
| 60 | 81.4 | 34.7 | 106.9 | 76.9 | 32.4 | 100.0 | 9.77 | 7% |
| Reheated | 135.9 | 39.6 | 122.0 | 114.4 | 35.8 | 110.5 | | 10% |

TABLE 7
Sample F Test Results

| | Heated | | | Non-Heated Reference | | | | |
|---|---|---|---|---|---|---|---|---|
| | | Temp | | | Temp | | | |
| | | Corr | | | Corr | | | % |
| | | Viscosity | | | Viscosity | | | hydration |
| Time (min) | Temp° F. | (cP) | % hyd | Temp° F. | (cP) | % hyd | pH | increase |
| 1.5 | 157.5 | 18.9 | 58.8 | | | | | |
| 1.75 | 156.25 | 24.3 | 75.5 | | | | | |
| 2 | 155 | 26.4 | 82.0 | | | | | |
| 2.5 | 152 | 29.2 | 90.8 | | | | | |
| 3 | 149 | 30.3 | 94.2 | | | | | |
| 3.5 | 147 | 31.0 | 96.5 | | | | | |
| 4 | 145.2 | 32.2 | 100.0 | | | | | |
| 4.5 | 143 | 32.4 | 100.8 | | | | | |
| 5 | 141.2 | 32.6 | 101.4 | | | | | |
| 10 | 124.2 | 33.7 | 104.8 | 74 | 30.2 | 93.8 | | 12% |
| 20 | 103.6 | 35.4 | 110.1 | 74.4 | 31.3 | 97.3 | | 13% |
| 30 | 92.8 | 36.0 | 112.0 | 75 | 31.7 | 98.6 | | 14% |
| 60 | 80.4 | 36.2 | 112.4 | 75.7 | 32.2 | 100.0 | | 12% |
| 80 | 77.2 | 36.5 | 110.6 | 75.6 | 31.8 | 96.5 | | 15% |
| 102 | 76 | 36.6 | 111.0 | 75.6 | 31.8 | 96.5 | | 15% |
| 1200 | 72.1 | 37.0 | 112.0 | 72.3 | 25.1 | 76.1 | | 47% |

TABLE 8
Sample G Test Results

| | Heated | | | Non-Heated Reference | | | | |
|---|---|---|---|---|---|---|---|---|
| | | Temp | | | Temp | | | |
| | | Corr | | | Corr | | | % |
| | | Viscosity | | | Viscosity | | | hydration |
| Time (min) | Temp° F. | (cP) | % hyd | Temp° F. | (cP) | % hyd | pH | increase |
| 2 | 155 | 28.5 | 84.1 | | | | | |
| 3 | 151.5 | 32.4 | 95.5 | 74.7 | 23.9 | 70.5 | | 35% |
| 4 | 147 | 34.5 | 101.7 | 74.7 | 27.2 | 80.2 | | 27% |
| 5 | 144.2 | 34.6 | 102.0 | 74.6 | 29.3 | 86.5 | | 18% |
| 10 | 125.5 | 36.0 | 106.2 | 75.2 | 31.8 | 93.7 | | 13% |
| 20 | 106 | 36.4 | 107.3 | 75.6 | 32.8 | 96.8 | | 11% |
| 30 | 95 | 37.5 | 110.5 | 76.3 | 33.5 | 98.6 | | 12% |
| 60 | 83.5 | 38.2 | 112.5 | 77.2 | 33.9 | 100.0 | | 12% |
| 1440 | 73.6 | 41.3 | 130.1 | 75.7 | 37.0 | 116.5 | | 12% |

### Example 3

### Heated Water Gel Hydration Test Results

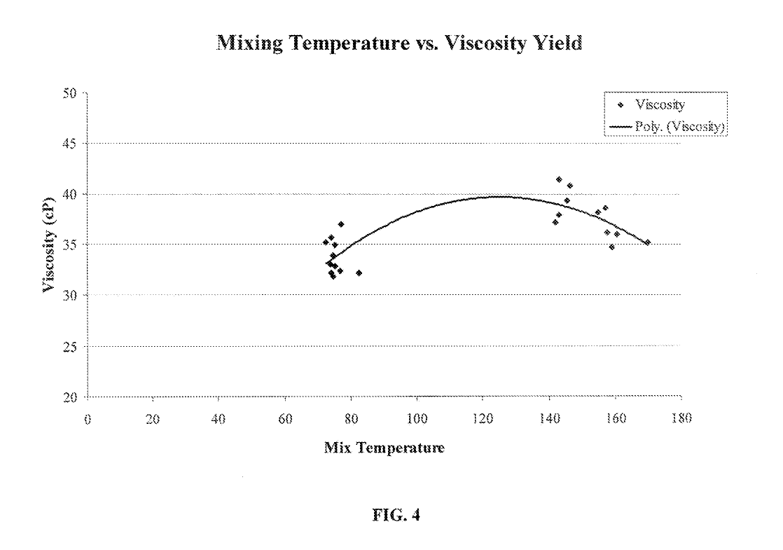

FIG. 4 is a graph of mixing temperature against viscosity for the hydration samples. The initial mixing temperature and viscosity of the sample results from Examples 1-2 were plotted. The points were used to determine a polynomial curve. The curve equation determined was y=−0.0024x2+0.5952x+2.4315, with an R² value=0.6277.

### Example 4

### Skillet Heating Gel Hydration Test

Other samples for gel hydration testing were prepared for testing using skillet heating rather than microwave heating. In addition, the samples were tested using different viscometers than in Examples 1 and 2. These samples were prepared using the amounts of materials, temperatures, and times as shown on Table 9 and the steps described below:
1. A first viscometer (Grace 3500A, available from Grace Instrument Company, Houston, Tex.) was setup and pre-heated using heated water at 165° F.

2. A second viscometer was setup (Fann Model 35) at room temperature.

3. About 300 ml, of deionized water was heated to a temperature of about 75-77° F.

4. The water was then placed in a blender jar, and stirred at 2,800 rev/min±10 rev/min using a Chandler Constant Speed Mixer 3060.

5. The amount of KG (as shown) was added to the blender jar while blending the water.

6. The amount of WG-35 dry gelling agent (available from Halliburton, Houston, Tex.) shown in Table 9 was added into the vortex (to form a 40 lb/Mgal) while blending the mixture.

7. After the mixing time reported in Table 9, the mixing was stopped, and 150 mL of the sample was poured into a sample cup, and 50 mL of the sample was poured into a beaker.

8. The 150 mL in the sample cup (“reference”) was placed on the second viscometer.

9. After mixing, the 50 mL sample in the beaker was placed briefly onto the top of an electric skillet (Rival) set to approx. 180° F. The sample was allowed to rest on the skillet for less than 5 seconds to achieve an elevated temperature. After heating, the mixture had the temperature shown in Table 2.

10. The beaker was removed from the skillet and placed on the first viscometer.

11. The first and second viscometers were set to 300 rev/min.

TABLE 9
Skillet Gel Hydration Test Method

| RUN # | W | X | Y | Z |
|---|---|---|---|---|
| lbs Gel/1000 gal | 40 | 40 | 40 | 40 |
| Water (g) (actual) | 300.45 | 300.75 | 300.87 | 300.50 |
| start Water Temp (F.) | 75.70 | 74.00 | 72.00 | 72.00 |
| Blender RPM (actual) | 2800 | 2800 | 2350 | 2350 |
| KCL g (actual) | 6.00 | 6.00 | 6.01 | 6.00 |
| Powder g (actual) | 1.45 | 1.44 | 1.42 | 1.44 |
| initial mix time sec (reqd) | 15 | 15 | 15 | 8 |
| Hi Temp (F.) | 146 | 143 | 142 | 146 |

### Example 5

### Skillet Heating Gel Hydration Test Results

The temperature, viscosity, and hydration % of the samples made according to the method of Example 3 were measured periodically, and are reported in Tables 10-13. The time reported was the elapsed time from the start of mixing in step 7. The Tables also report the % increase in viscosity at each sample time.

After tire viscosity reading taken at 30 minutes, the viscometers were stopped and the fluid allowed to remain static until the 59 minute point, at which time both viscometers were restarted, and the viscosity and temperature recorded at 60 minutes and later.

TABLE 10
Sample W Test Results

| | Heated | | | Non-Heated Reference | | | |
|---|---|---|---|---|---|---|---|
| | | Temp | | | Temp | | |
| | | Corr | | | Corr | | % |
| | | Viscosity | | | Viscosity | | hydration |
| Time (min) | Temp F. | (cP) | % hyd | Temp° F. | (cP) | % hyd | increase |
| 2 | 145.5 | 26.9 | 76% | 73.9 | 21.0 | 59% | 28% |
| 3 | 145 | 34.0 | 95% | 74 | 26.1 | 73% | 30% |
| 4 | 139.6 | 34.6 | 97% | 74 | 28.6 | 80% | 21% |
| 5 | 132.6 | 34.1 | 96% | 74 | 29.6 | 83% | 15% |
| 10 | 121.2 | 36.2 | 102% | 74.1 | 32.9 | 92% | 10% |
| 20 | 101.1 | 37.5 | 105% | 74 | 34.4 | 97% | 9% |
| 30 | 93.7 | 39.4 | 111% | 74 | 34.4 | 97% | 14% |
| 60 | 81.4 | 39.3 | 111% | 74 | 35.6 | 100% | 11% |
| 62 | 76.2 | 39.8 | 112% | 77.4 | 36.0 | 101% | 11% |

TABLE 11
Sample X Test Results

| | Heated | | | Non-Heated Reference | | | |
|---|---|---|---|---|---|---|---|
| | | Temp | | | Temp | | |
| | | Corr | | | Corr | | % |
| | | Viscosity | | | Viscosity | | hydration |
| Time (min) | Temp F. | (cP) | % hyd | Temp° F. | (cP) | % hyd | increase |
| 1.5 | 143.1 | 24.3 | 70% | 75.1 | 14.7 | 42% | 66% |
| 2 | 141.4 | 28.0 | 80% | 75.1 | 18.3 | 53% | 52% |
| 3 | 139.3 | 32.1 | 92% | 75.1 | 25.1 | 72% | 28% |
| 4 | 135.9 | 33.6 | 96% | 75.4 | 27.9 | 80% | 20% |
| 5 | 131.9 | 33.6 | 96% | 75.4 | 29.9 | 86% | 13% |
| 10 | 120.0 | 35.4 | 102% | 76.2 | 32.4 | 93% | 9% |
| 20 | 103.1 | 36.7 | 105% | 76.7 | 33.4 | 96% | 10% |
| 30 | 94.2 | 37.5 | 108% | 76.7 | 34.2 | 98% | 10% |
| 60 | 83.4 | 37.9 | 109% | 77.1 | 34.9 | 100% | 9% |
| 70 | 78.1 | 38.8 | 111% | 78.8 | 34.8 | 100% | 12% |

TABLE 12
Sample Y Test Results

| | Heated | | | Non-Heated Reference | | | |
|---|---|---|---|---|---|---|---|
| | | Temp | | | Temp | | |
| | | Corr | | | Corr | | % |
| | | Viscosity | | | Viscosity | | hydration |
| Time (min) | Temp F. | (cP) | % hyd | Temp° F. | (cP) | % hyd | increase |
| 1.5 | 141.9 | 22.0 | 66% | 75.1 | 13.3 | 40% | 65% |
| 2 | 141.8 | 26.9 | 81% | 75.2 | 18.4 | 55% | 46% |
| 3 | 140.9 | 31.6 | 95% | 75.2 | 23.8 | 72% | 33% |
| 4 | 136.8 | 33.0 | 99% | 75.2 | 27.1 | 82% | 22% |
| 5 | 132.8 | 33.8 | 102% | 75.3 | 29.3 | 88% | 15% |
| 10 | 119.5 | 35.4 | 107% | 75.6 | 30.7 | 92% | 16% |
| 20 | 102.4 | 36.5 | 110% | 76.0 | 32.2 | 97% | 13% |
| 30 | 93.7 | 37.2 | 112% | 76.4 | 32.8 | 99% | 14% |
| 60 | 82.0 | 37.0 | 111% | 76.6 | 33.2 | 100% | 11% |

TABLE 13
Sample Z Test Results

| | Heated | | | Non-Heated Reference | | | |
|---|---|---|---|---|---|---|---|
| | | Temp | | | Temp | | |
| | | Corr | | | Corr | | % |
| | | Viscosity | | | Viscosity | | hydration |
| Time (min) | Temp F. | (cP) | % hyd | Temp° F. | (cP) | % hyd | increase |
| 1.5 | 146.5 | 28.0 | 80% | 72.4 | 14.7 | 42% | 90% |
| 2.5 | 145.7 | 33.2 | 94% | 72.4 | 21.8 | 62% | 52% |
| 3 | 142.8 | 33.9 | 96% | 72.4 | 24.5 | 70% | 38% |
| 4 | 140.7 | 35.0 | 100% | 72.5 | 27.6 | 79% | 27% |
| 5 | 135.8 | 35.6 | 101% | 72.5 | 30.3 | 86% | 17% |
| 10 | 120.6 | 36.6 | 104% | 72.5 | 32.6 | 93% | 12% |
| 20 | 102.3 | 38.1 | 108% | 72.7 | 33.6 | 96% | 13% |
| 30 | 92.3 | 39.8 | 113% | 72.6 | 34.2 | 97% | 17% |
| 60 | 89.3 | 40.8 | 116% | 72.7 | 35.2 | 100% | 16% |

### Example 6

### Heated Mixture Gel Hydration Test Results

Samples for gel hydration testing were prepared using the amounts of materials, temperatures, and times as shown on Table 14 following the steps described below:

1. 5 grams KG was mixed into 250 mL of DI water that was preheated to approx. 77° F. until dissolved using a Chandler Constant Speed Mixer 3060.

2. 1.2 grams WG-35 dry gelling agent was microwaved on high for the time shown in Table 14 (0 or 15 sec).

3. After micro waving, the samples were allowed to rest at room temperature for the time shown in Table 14 (0 or 20 min) before being mixed into the Water/KCl solution. The combination was then mixed for 1 minute at 1200 rpm using a Chandler Constant Speed Mixer 3060.

4. The pH was measured.

5. Each sample was then placed on a Fann Model 35 viscometer at 300 rpm under continuous operation.

6. Periodically, measurements of the samples were taken as shown on Table 15.

7. The samples included a control sample (5A), a heated sample with immediate testing (5B) and a heated sample with delayed testing (5C). The reported measurements include the temperature, the viscosity corrected for temperature, and hydration %, measured as the viscosity compared to the viscosity of the control sample (5A) after 60 minutes.

TABLE 14
Heated Mixture Gel Hydration Test

| | 5A | | |
|---|---|---|---|
| | (control) | 5B | 5C |
| DI water, ml | 250 | 250 | 250 |
| KCl, g | 5 | 5 | 5 |
| WG-35, g | 1.2 | 1.2 | 1.2 |
| Microwave (sec) | 0 | 15 | 15 |
| Cooldown (min) | 0 | 0 | 20 |
| pH | 7.34 | 7.33 | 7.31 |

TABLE 15
Heated Mixture Gel Hydration Test Results

| | 5A (control) | | | 5B | | | 5C | | |
|---|---|---|---|---|---|---|---|---|---|
| | | Temp | | | Temp | | | Temp | |
| | | Corr | | | Corr | | | Corr | |
| Time | | Viscosity | | | Viscosity | | | Viscosity | |
| (min) | Temp F. | (cP) | % hyd | Temp F. | (cP) | % hyd | Temp F. | (cP) | % hyd |
| 2 | 75.5 | 28.1 | 69% | 74.2 | 33.0 | 81% | 74.8 | 26.2 | 65% |
| 3 | 75.5 | 32.6 | 80% | 74.2 | 37.2 | 92% | 74.8 | 29.1 | 72% |
| 4 | 75.4 | 35.1 | 87% | 74.1 | 39.2 | 97% | 74.7 | 30.4 | 75% |
| 5 | 75.3 | 36.1 | 89% | 74.0 | 40.8 | 101% | 74.6 | 31.1 | 77% |
| 10 | 75.1 | 38.0 | 94% | 73.9 | 43.3 | 107% | 74.5 | 33.2 | 82% |
| 60 | 75.3 | 40.5 | 100% | 74.6 | 47.2 | 116% | 73.2 | 34.9 | 86% |

### Example 7

### Heated Mixture Gel Hydration Test Results

Samples for gel hydration testing were prepared according to the procedure in Example 6 (except no pH measurements were taken), using the amounts and times as shown in Table 16.

The resulting measurements are reported in Table 17. The measurements include temperature results, the viscosity corrected for temperature, and hydration %, measured as the viscosity compared to the viscosity of the control sample (5A) after 60 minutes.

TABLE 16
Heated Mixture Gel Hydration Test 2

| | 6A | | |
|---|---|---|---|
| | (control) | 6B | 6C |
| DI water, ml | 250 | 250 | 250 |
| KCl, g | 5 | 5 | 5 |
| WG-35, g | 1.2 | 1.2 | 1.2 |
| Microwave (sec) | 0 | 15 | 30 |
| Cooldown (min) | 0 | 0 | 0 |

TABLE 17
Heated Mixture Gel Hydration Test 2 Results

| | 6A (control) | | | 6B | | | 6C | | |
|---|---|---|---|---|---|---|---|---|---|
| | | Temp | | | Temp | | | Temp | |
| | | Corr | | | Corr | | | Corr | |
| Time | | Viscosity | | | Viscosity | | | Viscosity | |
| (min) | Temp F. | (cP) | % hyd | Temp F. | (cP) | % hyd | Temp F. | (cP) | % hyd |
| 2 | 75.5 | 27.4 | 69% | 75.1 | 29.2 | 73% | 74.8 | 28.9 | 73% |
| 3 | | 31.1 | 78% | 75.1 | 32.2 | 81% | 74.7 | 31.8 | 80% |
| 4 | | 33.7 | 85% | 75.1 | 33.9 | 85% | 74.7 | 33.3 | 84% |
| 5 | | 34.5 | 87% | 75.1 | 34.9 | 88% | 74.7 | 34.4 | 87% |
| 10 | | 37.0 | 93% | 75.0 | 37.4 | 94% | 74.6 | 36.7 | 92% |
| 60 | | 39.8 | 100% | 74.4 | 40.7 | 102% | 75.0 | 40.2 | 101% |

A number of embodiments of the invention have been described. Nevertheless, it will be understood that various modifications may be made without departing from the spirit and scope of the invention. For example, changing the amount and type of materials used, the processing conditions including temperature and mixing speed, etc. Accordingly, other embodiments are within the scope of the following claims.

What is claimed is:

1. A process for increasing the yield of a hydratable material, comprising:
heating an aqueous component to a temperature of at least about 100° F.; and
mixing a hydratable material component and the heated aqueous component together to form a gel.

2. The process of claim 1, wherein the hydratable material, comprises a guar.

3. The process of claim 1, wherein the viscosity of the gel is it least 1% greater than a comparable gel formed using an aqueous component at a temperature less than 80° F.

4. The process of claim 1, wherein the viscosity of the gel is at least 5% greater than a comparable gel formed using an aqueous component at a temperature less than 80° F.

5. The process of claim 1, wherein the viscosity of the gel is at least 10% greater than a comparable gel formed using an aqueous component at a temperature less than 80° F.

6. The process of claim 1, wherein the aqueous component is heated to a temperature of about 110° F. to about 160° F.

7. The process of claim 1, wherein the aqueous component is heated to a temperature of about 130° F. to about 145° F.

8. The process of claim 1, wherein the process increases the yield of a hydratable material in a fracturing fluid.

9. A process for increasing the yield of a hydratable material, comprising:
heating a hydratable material component to a temperature of at least about 100° F.; and
mixing the heated hydratable material component and an aqueous component together to form a gel.

10. The process of claim 9, wherein the hydratable material comprises a guar.

11. The process of claim 9, wherein the viscosity of the gel is at least 1% greater than a comparable gel formed using a hydratable material having a temperature less than 80° F.

12. The process of claim 9, wherein the viscosity of the gel is at least 5% greater than a comparable gel formed using a hydratable material having a temperature less than 80° F.

13. The process of claim 9, wherein the hydratable material is heated to a temperature of at least about 120° F.

14. The process of claim 9, wherein the hydratable material is heated using microwaves.

15. The process of claim 9, wherein the process increases the yield of a hydratable material in a fracturing fluid.

16. A process for increasing the yield of a hydratable material, comprising:
heating a hydratable material component; and
mixing the heated hydratable material component and an aqueous component together to form a gel.

17. The process of claim 16, wherein the hydratable material component is heated using microwaves for at least 10 seconds.

18. The process of claim 16, wherein the hydratable material component is heated using microwaves for at least 15 seconds.

19. The process of claim 16, wherein the viscosity of the gel is at least 1% greater than a comparable gel formed using a non-heated hydratable material component.

20. The process of claim 16, wherein the viscosity of the gel is at least 5% greater than a comparable gel formed using a non-heated hydratable material component.
